(19) United States
(12) Patent Application Publication
(10) Pub. No.: US 2020/0094396 A1
(43) Pub. Date: Mar. 26, 2020

(54) Tool Holding and Storage Device

(71) Applicant: Bigfoot Construction Equipment, Inc., Woodstock, IL (US)

(72) Inventor: Jefferson Steiner, Woodstock, IL (US)

(21) Appl. No.: 16/582,043

(22) Filed: Sep. 25, 2019

Related U.S. Application Data
(60) Provisional application No. 62/736,511, filed on Sep. 26, 2018.

(51) Int. Cl. B25H 3/00

(52) U.S. Cl. CPC B25H 3/003

(57) ABSTRACT

The present disclosure relates to a tool holding and storage device, and specifically to an improved tool holder designed to securely hold tools of varying types and sizes in position within the holder regardless of the position of the holder. The present tool holding and storage device incorporates at least one magnet, which is positioned in conjunction with openings for receiving and retaining a variety of tools within the openings. The present tool holding and storage device is constructed from a self-lubricating material, which assists in preventing oxidation of the tools, thereby prolonging the life of the tools.

### TECHNICAL FIELD

The present disclosure relates to a device for organizing, holding and/or storing tools. More specifically, the present disclosure relates to a device for conveniently organizing, holding and storing tools, including screw drivers, wrenches, drill bits, sockets or socket wrench heads of varying sizes, as well as any number of related items. The tools and sockets stay in place within holding device through use of a plurality of magnets embedded within the body of the holder. Thus, the present magnetic tool holding and storage device releasably secures the items in place regardless of the positioning and movement of the holder, yet the items are readily accessible for use.

### BACKGROUND

Tools are used in multiple professions, for example, mechanics, construction workers and electrical linemen, as well as by the home improvement “do-it-yourselfer”. There is often a need or convenience to carry tools while on the job, such as on a tool belt or in portable toolboxes. In some situations, it is advantageous that the device for carrying and holding various tools is not only portable, but also secures the tools in such a manner that the tools cannot easily fall out of the carrier.

Popular tools are wrenches and other turning tools are used with socket sets to tighten or loosen a fastener. Ratchets, torque wrenches or impact wrenches are examples of turning tools used with sockets to tighten or loosen fasteners, such as nuts and bolts. Socket sets typically include a wide variety of sizes and shapes, suitable for nearly any use. It is convenient to have a variety of socket sizes available and easily accessible at one time, as the needs of any particular job can change. Socket set holders, which provide access to a variety of sockets, typically include clips or posts that are sized for receiving and holding a specific individual socket. However, over time, the clips or posts can weaken and break, and the sockets can be lost. Additionally, it is easy to misplace a socket on the post, and possibly lose that socket off the holder if the holder is tipped over or jostled around.

A need, therefore, exists for an improved tool holding and storage device. Specifically, a need exists for an improved tool holding and storage device, and specifically a device incorporating at least one magnet, or a plurality of magnets for securing a variety of sizes of tools within a single holder.

Moreover, a need exists for an improved tool holding and storage device which is self-lubricating for preventing oxidation and corrosion to the tools stored within the holder therefore extending the life of the tools.

A need further exists for an improved tool holding and storage device that magnetically secures the tools within the holder regardless of the positioning or movement of the holder, therefore preventing loss of the tools from the holder.

A need further exists for an improved tool holding and storage device that is durable and weather-resistant for use in any situation.

A need further exists for an improved socket holder that magnetically secures individual sockets in place within the holder, therefore decreasing the chances of losing the sockets regardless of the positioning or movement of the holder.

### SUMMARY

The present disclosure relates to a tool holding and storage device, and specifically to a tool holding device or tool holder, which is durable and retains the tools in place regardless of the positioning and movement of the holder. The present tool holding device incorporates a plurality of embedded magnets within the body of the device, for retaining an item having a magnetic affinity to the magnets within the device. The present tool holder also assists in prolonging the life of the tools stored therein through its self-lubricating properties and durable plastic construction. The portability of the present tool holder means it can be used in a variety of situations, including as a separate unit or as an attachment to a tool board, tool cabinet, vehicle, or just about any convenient location. The advantage offered by the present tool holder of securing the tools in place within the interior of the holder, means that the holder can be moved into a variety of positions, even upside down, without concern that the tools will fall out of the holder. This feature means less tool loss and improved costs savings. One example of a device of the present disclosure is a socket holder, which is designed to magnetically retain the socket heads within the body of the holder.

To this end, in an embodiment of the present disclosure, an improved tool holding and storage device is provided. The device includes a body formed from a top side, a bottom side, a front surface, a back surface, a first side and a second side opposing the first side, the body having a plurality of openings or holes of varying sizes and arrangement, wherein the openings are configured for receiving a specific tool or tools, or parts of tools, such as sockets. The openings extend from the top side of the body into the interior of the body and can be any depth to accommodate a specific tool. Optionally, the openings can extend completely through the body of the device. The device also includes a securing element in the form of at least one magnet, in close proximity to the openings. The magnetic affinity of the tools to the magnets within the body maintain the position of the tools within the openings, regardless of the position of the holder.

In another embodiment of the present disclosure, a tool holding and storage device is provided. The tool holding and storage device comprises a backboard, a body formed from a top side, a bottom side, a front surface, a back surface and two opposing side surfaces, the body secured to the backboard at the back surface, a plurality of individual openings disposed within the top side of the body, at least one magnet on the body, wherein the openings and magnet are configured for receiving and retaining a tool within each opening.

In another embodiment, a tool holding device is provided. The tool holding device comprises a body formed from a top side, a bottom side, and opposing side and front and back surfaces, a plurality of individual openings within the top side of the body, the individual openings each having an interior lubrication surface configured for receiving a tool, a plurality of magnets embedded within the body in close proximity to the openings, wherein the openings in conjunction with the magnets are configured for retaining a tool within each opening.

It is, therefore, an advantage and objective of the present disclosure to provide an improved tool holding and storage device, and specifically a device incorporating magnet for securing a variety of sizes of tools in a single holder.

It is a further advantage and objective of the present disclosure to provide an improved tool holding and storage device incorporating a plurality of magnets embedded within the body of the device.

It is yet another advantage and objective of the present disclosure to provide a tool holding and storage device that magnetically secures the tools within the body of the holder regardless of the positioning or movement of the holder.

It is further an advantage and objective of the present disclosure to provide a tool holding and storage device which is self-lubricating for preventing oxidation and corrosion to the tools stored within the holder therefore extending the life of the tools.

It is yet another advantage and objective of the present disclosure to provide an improved socket holder for securing individual sockets of varying sizes within a plurality of openings in a single device.

It is yet another advantage and objective of the present disclosure to provide an improved socket holder constructed from self-lubricating material, which assists in preventing corrosion on the sockets, thereby extending the life of the tools.

It is yet another advantage and objective of the present disclosure to provide an improved socket holder having a magnetic element that secures the individual sockets in place within the holder, which decreases the chances of losing the sockets.

It is another advantage and objective of the present disclosure to provide an improved socket holder that secures the individual sockets in place within the holder, regardless of the positioning or movement of the holder,

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a top view of an embodiment of an improved tool holding and storage device of the present disclosure;

FIG. 2 illustrates a rear and bottom view of the improved tool holding and storage device of FIG. 1;

FIG. 3 illustrates an interior view of another embodiment of the improved tool holding and storage device illustrating an arrangement of magnets;

FIG. 4 illustrates another embodiment of an improved tool holding and storage device of the present disclosure;

FIG. 5 illustrates a cut-away view of the improved tool holding and storage device of FIG. 4;

FIG. 6 illustrates another embodiment of the improved tool holding and storage device incorporating a plurality of magnets;

FIG. 7 illustrates another embodiment of the improved tool holding and storage device incorporating another arrangement of the plurality of magnets;

FIG. 8 illustrates another embodiment of the improved tool holding and storage device incorporating yet another arrangement of the plurality of magnets; and,

FIG. 9 illustrates another embodiment of the improved tool holding and storage device incorporating a further arrangement of the plurality of magnets.

### DETAILED DESCRIPTION

The present disclosure relates to tool holders, and specifically to an improved tool holding and storage device useful for securing a variety of tools and/or attachments to tools within the holder regardless of the positioning of the device. The tool holding and storage device may also be referred to simply as a tool holder. The present tool holding and storage device incorporates a magnet, and optionally, a plurality of embedded magnets for securing the tools within the device regardless of the position of the device. The tool holding and storage device is constructed from a self-lubricating, durable, weather resistant material, which assists in preventing oxidation of the tools, thereby prolonging the life of the tools. One example of a tool holding and storage device is a socket holder, which is designed to securely hold sockets of varying sizes in place regardless of the positioning of the device.

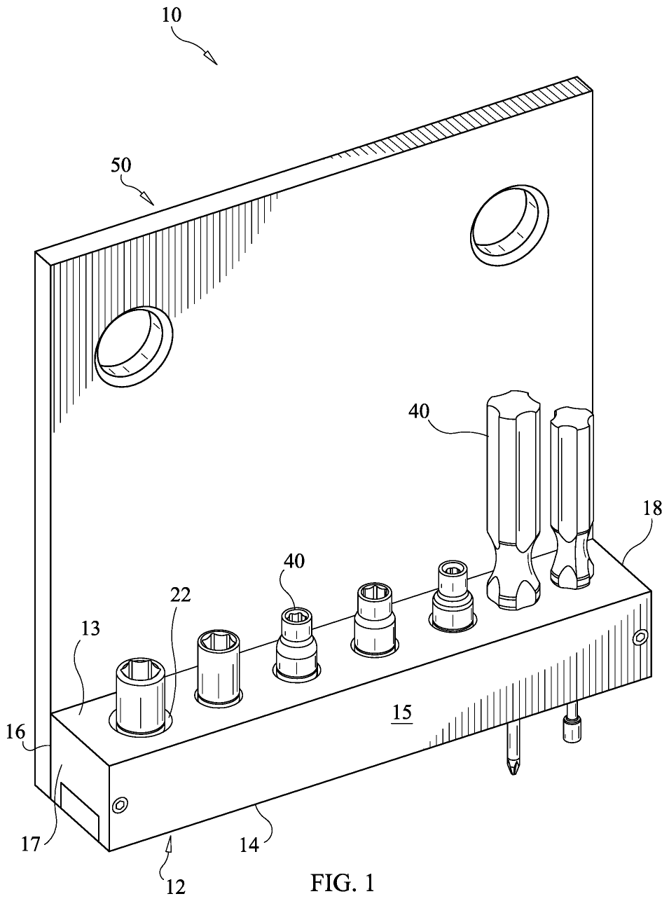

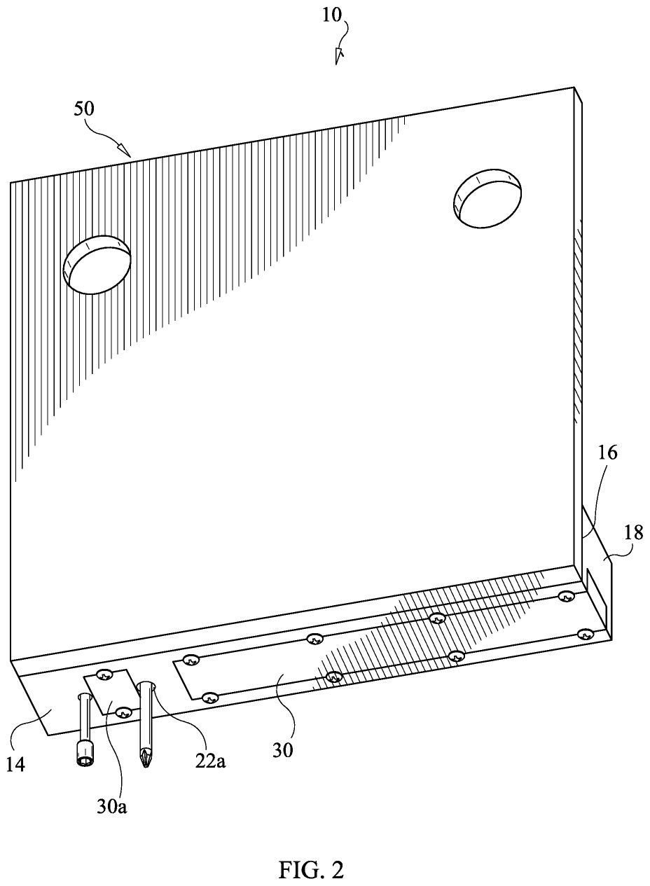

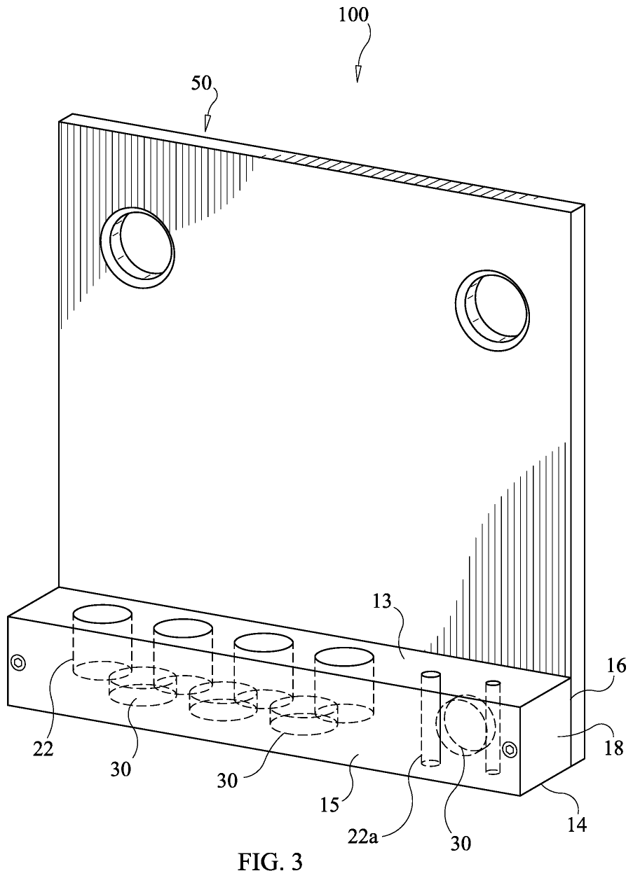

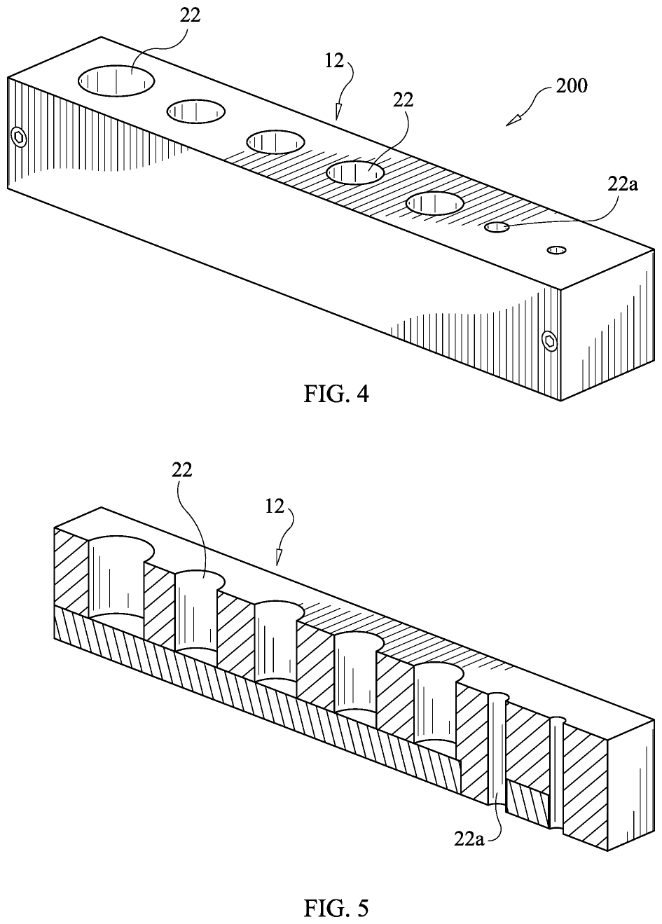

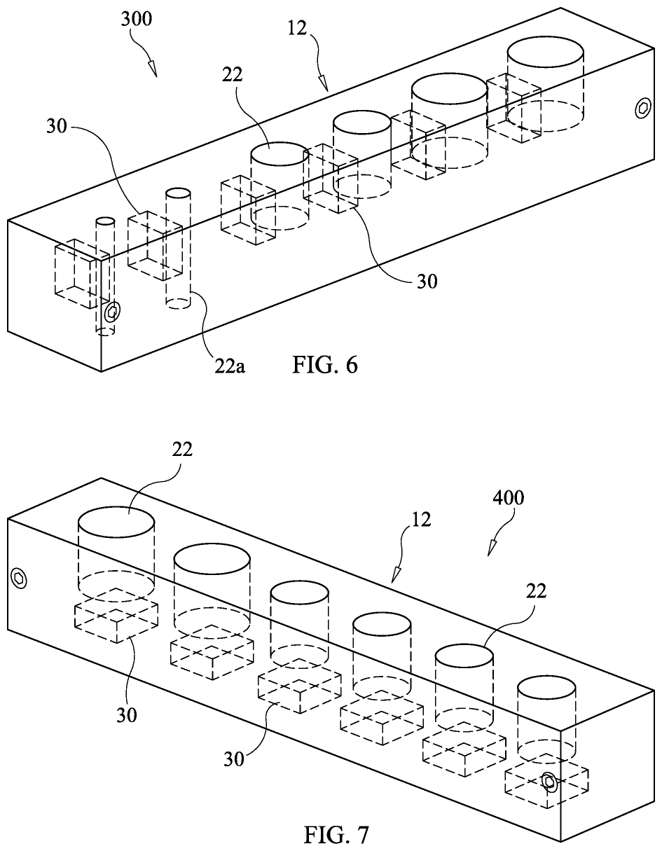

Now referring to the figures, wherein like numerals refer to like parts, FIGS. 1-3 illustrate an embodiment of the present tool holding and storage device 10 or tool holder with a backboard 50, which can be used for securing or mounting the tool holder to another object. FIGS. 1 and 2 illustrate an embodiment of the present tool holding and storage device 10 with magnets secured to the outer surface of the device. FIG. 3 illustrates an embodiment of the tool holder 10A with an arrangement of magnets within the body of the tool holder. FIGS. 4-5 illustrate an embodiment of the tool holding and storage device without the backboard. FIGS. 6-9 illustrate various embodiments of the tool holding and storage device having different arrangements of the magnet or magnets. Although specific embodiments are shown, it should be understood that the present tool holding and storage device 10 can be constructed in any suitable shape, and include any number, sizes and arrangement of openings for accommodating tools having a variety of sizes.

Referring now to FIGS. 1-3, there is shown embodiments of a tool holding and storage device or tool holder 10 of the present disclosure. The tool holder 10 includes a body 12 having a top side 13, a bottom side 14, a front surface 15, a back surface 16, a first side 17 and an opposing second side 18. Although the present holder 10 is shown having a rectangular shape, it should be understood that the holder can have any suitable shape. The body 12 of the tool holder 10 is secured using known attachment elements, to a backboard 50. In this embodiment, the backboard 50 is useful for securing the holder 10 to another object.

The present tool holder 10 is configured to hold a variety of tools 40 in place, regardless of the position and movement of the holder. Initially, and unlike other tool or socket holders that hold tools and/or sockets in place through posts or clips disposed vertically on a base, the present holder 10 is designed with a plurality of openings 22 formed within the body 12 of the holder, specifically on the top side 13 of the body. Although a certain number of openings 22 are represented in the accompanying figures, it should be understood that any number of openings 22 can be used in the present tool holding device 10, which can be customized for a particular customer or use. Additionally, openings 22 can be any variety of shapes, sizes diameters and even depths to accommodate the multitude of types and sizes of tools. The individual tools 40 are placed within the corresponding opening 22 based on size.

Generally, the openings 22 are designed to have a depth within, but not through, the body 12 of the holder. Optionally, some of the openings 22a may pass completely through the bottom side 14 of the body 12, which are designed or receiving tools such as screwdrivers (FIGS. 1 and 2). Unlike other forms of prior tool holders that may use posts, pins or clips to hold tools in place, tools can simply be slid into the openings 22 of the present holder 10 and be easily removed when needed. Post, pins and clips used in prior art tool holders are prone to change in size and may weaken and break with repeated use. Unlike posts, pins and clips, however, the openings 22 of the present holder 10 will not change in size, break or wear out.

An additional feature of the present tool holder 10 is that it is designed to maintain the tools 40 within the openings 22 regardless of the movement and positioning of the holder 10—for example—if the holder is positioned upside down. The tools 40 are releasably secured within the holder 10, ready for easy access. This additional securing feature is accomplished through use of at least one magnet and/or a plurality of magnets 30, which may be secured to the outer surface of the body 12 (FIG. 2) or preferably, embedded in a variety of positions and locations within the inside or interior of the body 12, such as the embodiment of the holder 100 shown in FIG. 3, and as in the embodiments 300-600 shown in FIGS. 6-9.

Any number and arrangement of magnets 30 can be used in the present holder 10, depending on the tools being stored. For example, as shown in FIG. 1, a single magnet 30 may be positioned along the length of the bottom side 14 outer surface of the body 12 of the device, and directly beneath the openings 22. Additionally, a second separate magnet 30a, may be placed also on the bottom side 14 outer surface between the pass-through openings 22a (FIG. 2).

Optionally, a plurality of magnets 30 may be embedded within the body 12 of the device, as in the embodiment of the holder 100 of FIG. 3. Embedding the magnets also contributes to the longevity of the magnets and device, because the magnets are not exposed to the elements or other factors that may potential damage them. FIGS. 3 and 5-9 illustrate various embodiments of tool holder illustrating placement and arrangement of a plurality of magnets 30. For example, FIG. 3 illustrates an embodiment of the present device 100 having a plurality of magnets 30 within the interior of the body 12. The magnets 30 are positioned beneath and spanning portions of the openings 22, with at least one magnet along the side of the openings 22a.

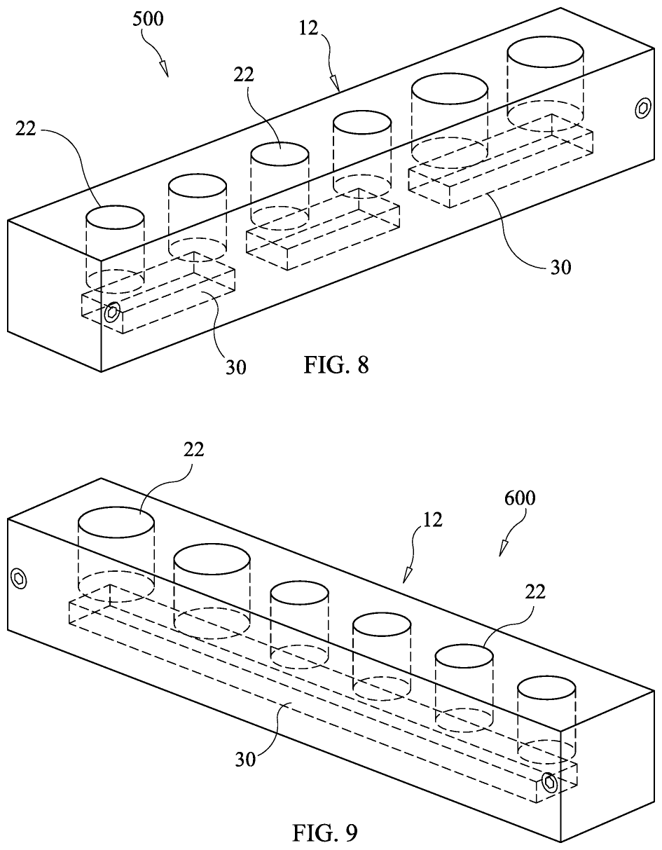

Similarly, FIG. 6 illustrates an embodiment of the holder 300 having a plurality of magnets 30 within the interior of the body 12 and positioned along the sides of each of the openings 22. FIG. 7 illustrates an embodiment of the holder 400 having a plurality of magnets 30 within the interior of the body 12 corresponding with and directly beneath each opening 22. FIG. 8 illustrates an embodiment of the holder 500 having a plurality of magnets 30 within the interior of the body 12 positioned at the bottom of and offset from, or spanning portions of, each of the individual openings 22. FIG. 9 illustrates an embodiment of the holder 600 having a single magnet 30 within the the interior of the body 12 along the entire length of the holder body 12 and running beneath all of the openings 22. It should be understood that any number, combination and placement of a plurality of magnets 30 or a single magnet can be used in the present holder 10, 100-600 to accomplish securing the sockets and/or tools within the holder. Additionally, although the magnets are shown as having a round, square or rectangular shape, the magnets can have any shape suitable for a particular device.

Use of the magnets 30 within the openings 22, 22a means that even if the wrong tool 40 or socket is placed within an opening, for example, a smaller sized socket placed into a larger opening, the magnet will hold the socket in place until the socket is removed. Again, there is less likelihood of losing tools while on a job by using the present tool holder 10. Rare earth magnets are particularly desirable for use in the present holder 10 because they are made from alloys of rare-earth elements and are the strongest type of permanent magnet, producing significantly stronger magnetic fields than other types such as ferrite or alnico magnets. These types of magnets are ideal for securing tools in position in the present device 10, 10A.

An advantage and feature of the present tool holder 10, including holder embodiments 100-600, apart from other holders in the art, is that the present holders can be moved in a variety of positions, even upside down, without losing the tools and/or sockets from their openings 22, 22a within the holder. Use of the magnet 30 or plurality of magnets in various arrangements within the interior of the body 12 of the holder 10, proximate to and/or corresponding with the openings 22, 22a assists in maintaining the tools 40, sockets and other items within the openings of the holder regardless of the positioning of the holder. Less chance of losing tools 40 from the present tool holder 10 minimizes tool loss, saving on costs, time and energy, while maintaining the tools in position so they are readily accessible and organized for the user.

Another advantage of the present tool holder 10 and holders 100-600 is durability. The tool holding and storage device of the present disclosure can be constructed from any durable material. A unique feature of the present holder is that it is constructed from ultra-high-molecular-weight polyethylene (UHMWPE). This material is not only moldable and durable, but also resistant to corrosive chemicals, and is ideal for use in construction of the present holder. UHMWPE is naturally self-lubricating. The lubrication properties of the polyethylene used in the present holders reduces oxidation of the metal sockets or tools 40 placed within the openings 22 of the holders, thereby extending the life and quality of the tools stored within the various embodiments of the holders.

Construction of the various embodiments of the present tool holding and storage devices is accomplished using known methods. For example, the body 12 of the tool holder 10 can be formed from polyethylene material that is pressed with a PSI value of 3,000 per cubic inch to form the body into the desired shape. Although a rectangular shaped holder is shown, it should be understood that the tool holding and storage device 10 can be constructed in any suitable shape, including custom shapes depending on the tools the device will be storing. Additionally, the present tool holder can include a backboard 50, or be constructed without the backboard. The openings 22, 22a in the body 12 of the device 10 are bored out using known techniques, and are preferably variable sizes for receiving variety of tools, including sockets/screw drivers, drill bits, wrenches, etc. As well, any number of openings 22 can be created within the tool holder 10, depending on the requirements of a specific customer.

It should be understood that although certain embodiments are shown, the tool holder 10 can be designed and constructed to accommodate a multitude of tools, including screw drivers, drill bits, wrenches, etc., essentially anything with a magnetic attraction. The unique features of securing the tools within the tool holder 10, regardless of the positioning and movement of the holder, can be adapted to accommodate a variety of tools.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A tool holding and storage device comprising:
a body formed from a top side, a bottom side, a front surface, a back surface, a first side and a second side opposing the first side;
a plurality of individual openings disposed within the top side of the body;
at least one magnet on the body, wherein the openings and magnets are configured for receiving and retaining a tool within each opening.

2. The tool holding and storage device of claim 1, wherein the openings extend from the top side of the body into an interior of the body.

3. The tool holding and storage device of claim 2, wherein the openings have a random arrangement on the top side.

4. The tool holding and storage device of claim 2, wherein the openings have a longitudinal arrangement along the top side of the body.

5. The tool holding and storage device of claim 1, wherein the individual openings each have different circumferences.

6. The tool holding and storage device of claim 1, wherein the individual openings each have a same circumference.

7. The tool holding and storage device of claim 1, wherein the magnet is positioned along a length of an outer surface of the bottom of the body.

8. The tool holding and storage device of claim 1 wherein the magnet is embedded within the body and beneath the individual openings.

9. The tool holding and storage device of claim 1, wherein the device includes a plurality of magnets embedded within the body.

10. The tool holding and storage device of claim 9, wherein the magnets are embedded within the body along a side of each individual opening.

11. The tool holding and storage device of claim 9, wherein the magnets are embedded within the body beneath and spanning portions of at least two individual openings.

12. The tool holding and storage device of claim 9, wherein the magnets are embedded within the body beneath each individual opening.

13. The tool holding and storage device of claim 1, wherein the body and individual openings of the device are constructed from an ultra-high-molecular-weight polyethylene.

14. The tool holding a storage device of claim 13, wherein ultra-high-molecular-weight polyethylene provides a lubrication surface to an interior surface of the individual openings.

15. The tool holding and storage device of claim 14, wherein the interior surface is configured for receiving a tool.

16. A tool holding device comprising:
a backboard;
a body formed from a top side, a bottom side, a front surface, a back surface and two opposing side surfaces, the body secured to the backboard at the back surface;
a plurality of individual openings within the top side of the body, the individual openings each having an interior lubrication surface configured for receiving a tool;
a plurality of magnets embedded within the body in close proximity to the openings, wherein the openings in conjunction with the magnets are configured for retaining a tool within each opening.

17. The tool holding device of claim 16, wherein the openings have an arrangement of various sizes.

18. The tool holding device wherein the magnets are embedded along at least one side of each individual opening.

19. The tool holding device of claim 16, wherein the magnets are embedded within the body beneath each individual opening.

20. The tool holding device of claim 16, wherein the magnets are embedded within the body of the device and spanning portions of at least two openings.
